(19) United States
(12) Patent Application Publication
(10) Pub. No.: US 2014/0164050 A1
(43) Pub. Date: Jun. 12, 2014

(54) Process Model Visualization Methods

(71) Applicant: PERCEPTIVE SOFTWARE RESEARCH AND DEVELOPMENT B.V., Apeldoorn (NL)

(72) Inventors: Gueorgui Ivanov Jojgov, Eindhoven (NL); Petrus Cornelis Wilhelmus van den Brand, 's-Hertogenbosch (NL)

(73) Assignee: PERCEPTIVE SOFTWARE RESEARCH AND DEVELOPMENT B.V., Apeldoorn (NL)

(21) Appl. No.: 13/894,937

(22) Filed: May 15, 2013

Related U.S. Application Data
(60) Provisional application No. 61/647,501, filed on May 15, 2012.

(51) Int. Cl. G06Q 10/06

(52) U.S. Cl. CPC G06Q 10/0633
USPC 705/7.27

(57) ABSTRACT

A method of comparing process models at least two process models to determine differences and similarities in the at least two process models. The process models include at least two states and a transition. The method includes comparing the state and the transition of the at least two process models, identifying differences in the state and the transition of the at least two process models, and visually representing the at least two process models in a user interface, wherein the differences in the state and the transition of the at least two process models are indicated in a first format different from a second format that indicates similarities in the transition and state of the at least two process models.

### CROSS REFERENCES TO RELATED APPLICATIONS

The present application is related to and claims priority under 35 U.S.C. 119(e) from U.S. provisional application No. 61/647,501, filed May 15, 2012, entitled, “Process Model Visualization,” the content of which is hereby incorporated by reference herein in its entirety. The present application also relates to U.S. non-provisional patent application entitled, “Process Model Visualization Methods” which was filed contemporaneously herewith.

### STATEMENT REGARDING FEDERALLY SPONSORED RESEARCH OR DEVELOPMENT

None.

### REFERENCE TO SEQUENTIAL LISTING, ETC.

None.

### BACKGROUND

1. Field of the Disclosure

The present disclosure relates generally to process modeling, and more particularly to process model visualization.

2. Description of the Related Art

Businesses often record or store data or information, such as in a data log, relating to business or workflow processes implemented in a system. This type of data may be highly valuable to a company desiring to better understand the workflows involved in accomplishing a particular process goal by providing insight on how existing processes are being implemented by users of the system. This data may also help a company in determining whether its current processes are operating as intended, identifying bottlenecks or areas which need improvement or affect the efficiency of the process and/or assessing the effect of process changes.

In order to help businesses better understand their business or workflow processes more effectively, the processes may be automatically modeled using actual process data. Additional insight on the efficiencies and effectiveness of a process may be gleaned if at least two processes can be compared. For example, such comparisons may be used to more readily identify similarities and distinguish differences between two processes. They may also more readily demonstrate the effects of a modification on a process or validate whether a process is being executed as intended. This comparison may be between a process model and a process generated from actual process data. It may also be a comparison of the process using data from two different periods of time. The comparison may also be between an original process and a modified version of such process.

Thus, what is needed is a system and method for automatically, effectively and efficiently visualizing multiple processes or a single process at multiple points in time from a set of raw data and a method and a system for comparing process models across different departments, countries, business units, time period, and many others. The system and method may automatically compare different instances of a process (e.g., how purchasing processes differ for various products, price ranges, etc.) and visually present the differences and similarities between at least two process models. Such system and method for visualizing data in model form is needed for identifying deviations from the defined boundaries or expectations that a company may have for implemented business processes.

### SUMMARY

A system capable of and methods for automatically creating visual displays and comparing processes are disclosed herein. Comparisons may be made using model data and/or real raw data. In one example embodiment, the comparison may be between a process model and a process generated from actual process data. In another example embodiment, the comparison may be between multiple processes. In yet another example embodiment, the comparison may of a single process using data from two different periods of time. In still another embodiment, the comparison may also be between a process and a modified version of such process.

According to one example embodiment, the method of comparing process models includes receiving at least two process models. The method also includes comparing the states and the transitions of the at least two process models, identifying similarities and differences in the states and the transitions of the at least two process models and visually representing the at least two process models in a user interface, wherein the differences in the states and the transitions of the at least two process models are indicated in a format different from a format that indicates similarities in the transitions and the states of the at least two process models.

In one aspect of the first embodiment, the method may include mining a data set to generate at least one of the at least two process models. In another aspect, the identifying the similarities in the at least two process models may include identifying labels common to the state of the at least two process models. In yet another aspect, the format for indicating the differences may be a first color and the format for indicating the similarities may be a second color.

In another aspect of the first embodiment, the format for indicating the differences may be a first line type and the format for indicating the similarities may be a second line type. In another aspect, the format for indicating the differences may be a first pattern and the format for indicating the similarities may be a second pattern. In yet another aspect, the visually representing the at least two process models may include visually representing the at least two process models as a single process model.

In another aspect of the embodiment, the single process model may show the differences in a format different from a format that shows the similarities. In another aspect, the visually representing the at least two process models may include positioning the states and the transition occurring in a first process model in a layout that preserves a structure of the first process model. In yet another aspect, performance information regarding the at least two process models may be displayed.

### BRIEF DESCRIPTION OF THE DRAWINGS

The above-mentioned and other features and advantages of the disclosed embodiments, and the manner of attaining them, will become more apparent and will be better understood by reference to the following description of the disclosed embodiments in conjunction with the accompanying drawings. Like reference numerals are used to indicate the same element throughout the specification.

FIG. 1 is one example embodiment for process model visualization.

FIG. 2 is one example process for use in the process model visualization of FIG. 1.

FIG. 3 is a second example process for use in the process model visualization of FIG. 1.

FIG. 4 is one example combined process model visualization of the example processes of FIGS. 2 and 3, with the example process of FIG. 2 as the reference process.

FIG. 5 is a second example combined process model visualization of the example processes of FIGS. 2 and 3, with the example process of FIG. 3 as the reference process.

FIG. 6 is one example embodiment of a method of positioning states and transitions that occur in one process but not a second process when comparing two or more process models.

FIG. 7 is a second example combined process model visualization of the example processes of FIGS. 2 and 3, with the example process model of FIG. 2 as the reference process, in accordance with another aspect of the present disclosure.

FIG. 8 is a third example combined process model visualization of the example processes of FIGS. 2 and 3, with the example process model of FIG. 2 as the reference process, in accordance with another aspect of the present disclosure.

### DETAILED DESCRIPTION

It is to be understood that the present disclosure is not limited in its application to the details of construction and the arrangement of components set forth in the following description or illustrated in the drawings. The disclosure is capable of other embodiments and of being practiced or of being carried out in various ways. For example, other embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the application encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Unless limited otherwise, the terms “connected,” “coupled,” “mounted,” and variations thereof herein are used broadly and encompass direct and indirect connections, couplings, and mountings. In addition, the terms “connected” and “coupled” and variations thereof are not restricted to physical or mechanical connections or couplings.

Spatially relative terms such as “top”, “bottom”, “front”, “back”, “rear” and “side” “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

In addition, it should be understood that embodiments of the present disclosure include both hardware and electronic components or modules that, for purposes of discussion, may be illustrated and described as if the majority of the components were implemented solely in software.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the descriptions below.

These computer program instructions may also be stored in a non-transitory tangible, computer-readable storage medium that may direct a computer or other programmable data processing apparatus to function in a particular manner, such that the instructions stored in the computer-readable storage medium may produce an article of manufacture including an instruction means that implements the function specified in the block or blocks. Computer readable storage medium includes, for example, disks, CD-ROMS, Flash ROMS, nonvolatile ROM and RAM. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks. Output of the computer program instructions, such as the process models and the combined process models, as will be described in greater detail below, may be displayed in a user interface or computer display of the computer or other programmable apparatus that implements the functions or the computer program instructions. A process or workflow may be viewed as a sequence of steps or interactions that are performed to achieve a stated purpose or goal. A step or interaction may itself be a subprocess having its own sequence of steps or interactions. Process models may be visually represented by a combination of states and transitions that show how a process is executed in a given system. States may be the events, actions or operations of a process. For example, states may represent steps in a process or workflow. State labels may be identifiers, such as text, that correspond to the states in a process model.

Transitions in a process model may illustrate the direction or movement between an input state and an output state. The input state of a transition may correspond to an event, action or operation that leads the input state to the output state. The output state of a transition may correspond to the event, action or operation that occurs after the input state of the transition.

In some example embodiments, process models may be created manually by a user. For example, a user may illustrate a process model by hand or using graphics software. A process model may then be printed or stored electronically for future use.

In other example embodiments, process models may also be automatically generated from data sets, such as an event log, using conventional or proprietary process mining techniques. As will be understood by those of ordinary skill in the art, process mining is the method for extracting process models from data sets, and conventional process mining techniques include alpha, genetic mining, heuristic and fuzzy mining algorithms.

Data sets may include data entries wherein each entry has a case identifier, time stamp and state information. A case identifier may refer to a recorded indicator, such as a number, that identifies which activities are associated with a particular process instance. For example, a case identifier may uniquely identify the object, subject or item going through a state. A time stamp may refer to a date and/or time at which a case may have arrived at a particular state. State information may be a description of the state and may represent, for example, an activity, transaction type, physical location or name identifier.

In yet other example embodiments, process models may be generated by a combination of manual techniques and automatic process mining techniques.

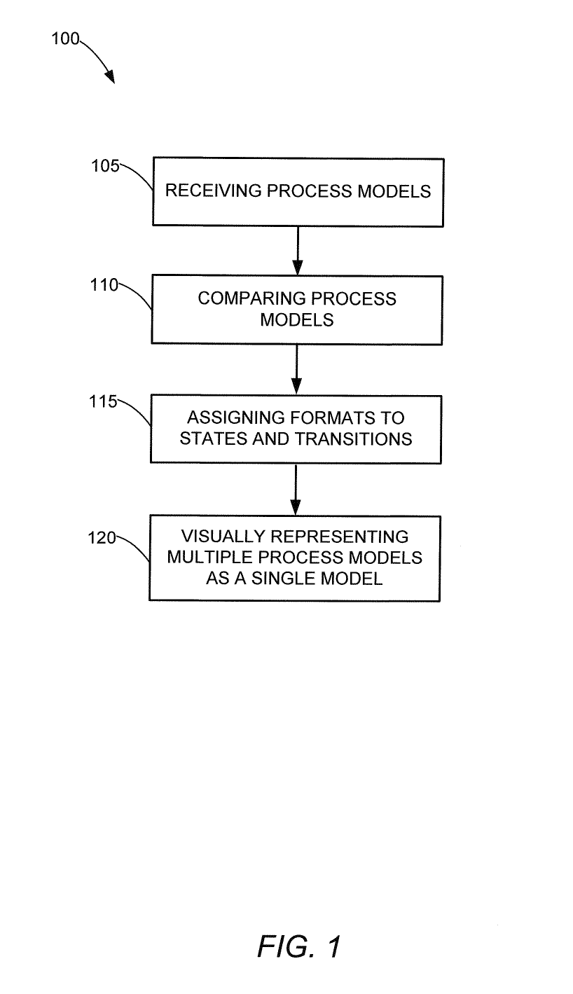

FIG. 1 illustrates one example embodiment for process model visualization. At block 105, the process models are received. The process models are compared at block 110. Formats for the states and transitions may be assigned at block 115, and the process models may be visually represented as a single model (block 120).

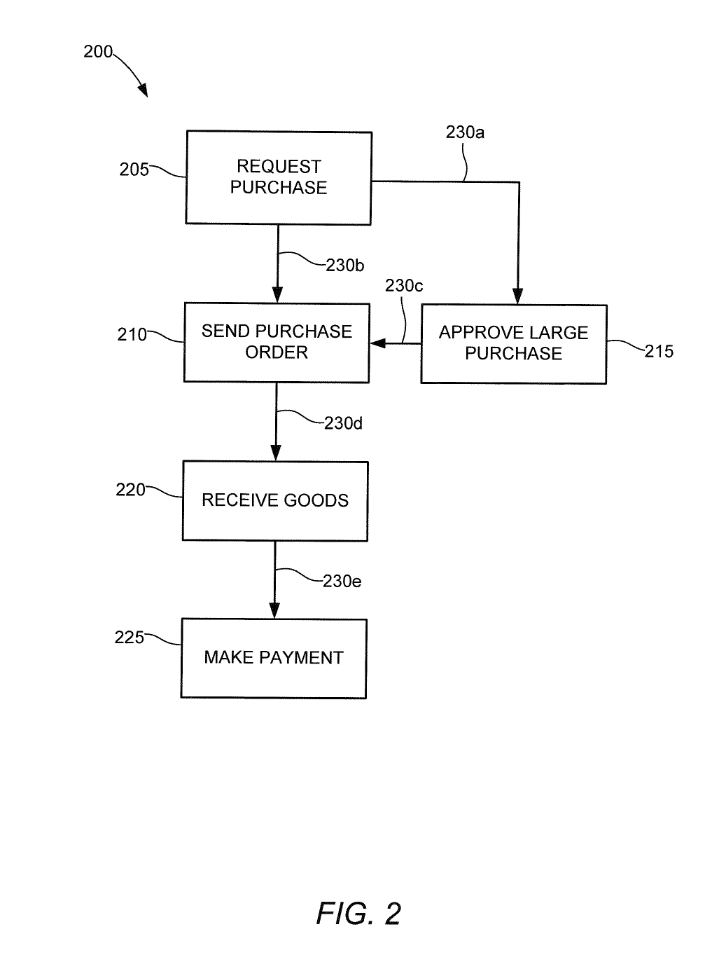

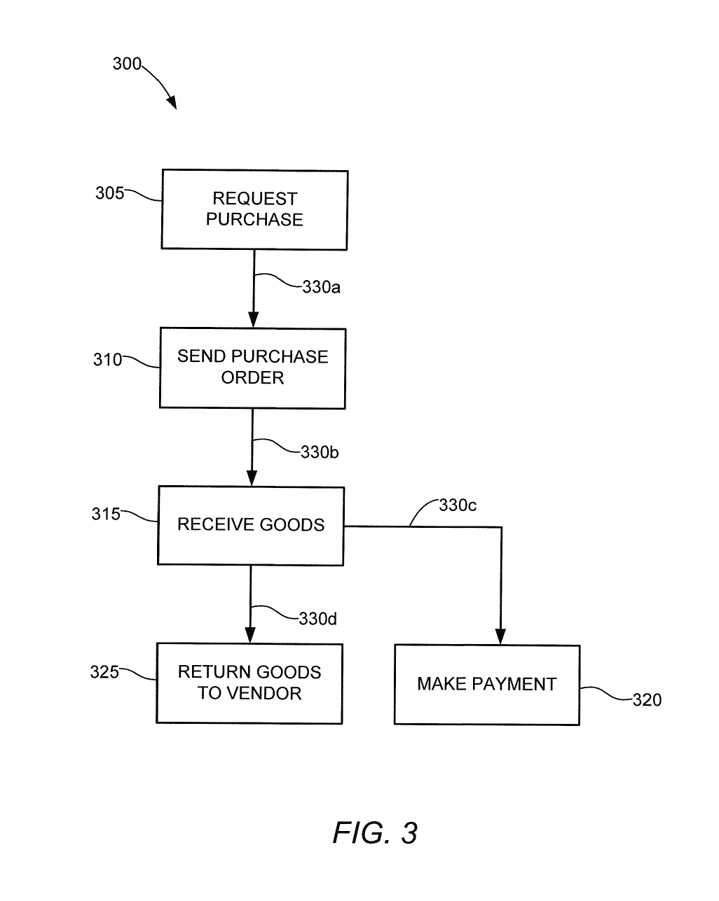

FIGS. 2 and 3 are example process model variations of a purchasing procedure and are merely utilized to illustrate process model visualization in one example embodiment. Process model visualization, however, is not limited to purchasing procedure process modeling. Rather, process model visualization is applicable to any workflow or process used in any business or industry.

At block 105, at least two process models for comparison may be received by the application from a user. In some example aspects, the process models may be multiple processes that share a common goal even if they are part of differing industries or businesses. For example, one process model may be for an appeals process for property zoning while another process model may be for an appeals process for a court system. In other example aspects, the process model may be a single process at multiple points in time or variations of a single process. For example, the process model comparison may be for a purchasing process used in a business or industry that has been modified or for a purchasing process being evaluated for different time periods, such as different years.

As shown in FIG. 2, example purchasing procedure process 200 begins with a request for a purchase and ends when a payment is made. Process model 200 may include states or activities 205, 210, 215, 220 and 225, which may be indicated by state labels Request Purchase for state 205, Send Purchase Order for state 210, Approve Large Purchase for state 215, Receive Goods for state 220, and Make Payment for state 225.

Transitions in process model 200 may be transitions 230a, 230b, 230c, 230d and 230e. Each transition may have at least one input state and at least one output state, and the input state may represent the state, event or activity that precedes the output state. For example, transition 230a of process model 200, has an input state of Request Purchase 205 and an output state of Approve Large Purchase 215, and transition 230b may have an input state of Request Purchase 205 and an output state of Send Purchase Order 210.

In another example process model, as shown in FIG. 3, process model 300 may be a visualized business process model of a second purchasing procedure that begins in a request for a purchase and may end in two states: when a payment is made and when goods are returned to vendor.

Process model 300 may include states 305, 310, 315, 320 and 325 which may be indicated by state labels Request Purchase for state 305, Send Purchase Order for state 310, Receive Goods for state 315, Make Payment for state 320 and Return Goods to Vendor for state 325.

Transitions in process model 300 may be transitions 330a, 330b, 330c and 330d. Similar to process model 200, the transitions may have at least one input state and at least one output state. The transition between the input state and the output state may lead the input state to the output state. The output state of a transition may correspond to the event or state that occurs after the input state of the transition. For example, Receive Goods state 315 may be the input state of transition 330d and may be the state or event that precedes Return Goods to Vendor state 325, which may be the output state of transition 330d. Receive Goods state 315 may also be the input state for transitions 330c.

While this example embodiment shows process models 200 and 300 as flow chart models, it will be appreciated by those of ordinary skill in the art that other models may be used. Other example models may include, but are not limited to, functional flow diagrams, control flow diagrams, Petri nets or state diagrams.

Referring back to FIG. 1, the example process models 200 and 300 may be compared at block 110. Comparing the process models may include identifying in which of the process models each state and each transition occurs. In one example embodiment, comparing the process models may include identifying whether a state or a transition occurs in one process model but not in the other, or if a state or a transition occurs in more than one process model.

Determining whether a state is present in multiple models may include state label matching. State label matching includes identifying a state in one process model and determining whether the state identified in the one process model occurs in a second or in another process model. In one example embodiment, state labels are matched when two or more process models are determined to contain the same state label. For example, Request Purchase state 205 may be identified to occur in process model 200. State label matching may search for a state in process model 300 that contains the state label Request Purchase. In the illustrative example embodiment involving FIGS. 2 and 3, state label matching occurs for Request Purchase state 305 in process model 300.

In another alternative example aspect, state label matching may be accomplished through the use of a translation table of state labels from one model to another. The translation table may include identifying whether a state in a first process model matches a state in a second process model using similarities in the state labels of the a state in a first process model with a state in a second or another process model.

For example, if a first process model, which may also be referred as reference model, contains a state having a state label “Send Purchase Order”, and the second process model includes a state having a state label “Send Order”, the translation table may identify that the two state labels “Send Purchase Order” and “Send Order” refer to the same state or event. The application may then translate, modify or change the state label in one process model to the same state label in the other process model. Using the two state labels as an illustrative example, the “Send Order” of the second process model may be changed or translated to “Send Purchase Order” to match the state label in the reference model. In one alternative aspect, the translation table may associate the two states without changing the state labels in the process models.

In some alternative example embodiments, the matching of the state labels of the two process models may be performed prior to the comparison of the process models.

Determining whether a transition is present in multiple process models may include identifying the input state and the output state of a transition. If the input and output states are the same for a transition in at least two process models, then the transition is determined to be present in both or multiple process models. For example, process models 200 and 300 may be compared to identify transitions that are present in both process models. In process model 200, transition 230b is identified to have an input state having state label “Request Purchase” 205 and an output state having state label “Send Purchase Order” 210. In process model 300, transition 330a has an input state with the state label “Request Purchase”305 and output state with a state label “Send Purchase Order” 310. Thus, transition 330a is determined to be present in both process models 200 and 300, and there is a transition match.

On the other hand, if a transition in one process model is present in a particular process model but not in the reference model or, alternately, present in the reference model but not in the particular process model, the transition fails to match. For example, process model 200 may be set as the reference model, and transition 230a may be checked to see if it is present in other process models. Transition 230a includes an input state 205 having state label “Request Purchase”, and an output state 215 having output state “Approve Large Purchase”. Determining if transition 230a is present in process model 300 may include finding an input state having a matching (or at least associated) state label as that of the input state Request Purchase of transition 230a. In process model 300, transition 330a contains an input state 305 having state label “Request Purchase”, which matches the input state of transition 230a. However, the output state of transition 330a is Send Purchase Order state 310, which is different from the output state Approve Large Purchase 215 of transition 230a. Request Purchase state 305 is identified as having no other connection to another state apart from output state 310 Send Purchase Order through transition 330a. Because both the input state and the output state are not the same for transition 230a of process model 200 and transition 330a of process model 300, transition 230a in process model 200 is determined to be present in the reference process model 200 but not in process model 300.

As will be appreciated by those of ordinary skill in the art, transition matching may involve the use of a state label translation table in some example embodiments. For example, if a transition in a first process model has an input state with a state label “Request Purchase” and an output state has a state label “Send Purchase Order” and a transition in a second or another process model has an input state with a state label “Request Purchase” and an output state has a state label “Send Order”, a translation table may be used to verify or confirm whether the two output state labels “Send Purchase Order” and “Send Order” refer to the same state or event. If there is a translation or association between the state labels of the different process models, the transition is identified as being the same transition.

In some alternative example embodiments, the comparison of process models may involve determining whether each state and each transition from each model belongs to a subset of models. For example, if state A occurs in each of three process models XYZ, then the subset of state A is {X,Y,Z}.

For example, states 205 and 305 may be determined to be identical states and present in both process models 200 and 300. Thus, the subset for states 205 and 305 would be {process model 200, process model 300}. In another example, state 215 may be determined to occur in process model 200 but not in process model 300. Thus, the subset for state 215 would to be {process model 200}.

For illustrative purposes, the states and transitions of the process models shown FIGS. 2 and 3 having the subset of models {process model 200, process model 300} includes: Request Purchase states 205 and 305, Send Purchase Order states 210 and 310, Receive Goods states 220 and 315, Make Payment states 225 and 320, and transitions 230b and 330a; 230d and 330b; and 230e and 330c. The states and transitions determined to have a subset of models {process model 200} include: Approve Large Purchase state 215 and transitions 230a and 230c. The states and transitions determined to have a subset of models {process model 300} include: Return Goods to Vendor state 325 and transition 330d.

Returning to FIG. 1, formats may be assigned to each state and transition at block 115. The format assigned to each state and transition may be based on the differences between and similarities of at least two process models. For example, if process model 200 is determined to have a state or a transition that occurs in process model 200 but does not occur in process model 300, each of these states and transition may be assigned a broken line pattern, and a different format may be assigned to the states and transitions which occur in both all of the process models being compared. For example, the states and transitions that occur in both process models 200 and 300 may be assigned a single line format to indicate that the states and transitions are similar or occur in each of the process models.

In another aspect, formats may be assigned to each subset. Formats may be line types, colors, patterns or any other format capable of visually distinguishing between similar and differing states and/or transitions. For example, subset {process model 200, process model 300} may be assigned a single line pattern, subset {process model 200} may be assigned a broken line pattern, and subset {process model 300} may be assigned a double line pattern.

Each state and transition may be assigned the format corresponding to the format assigned to the subset. For example, the states and transitions having the subset {process model 200, process model 300} which include Request Purchase states 205 and 305, Send Purchase Order states 210 and 310, Receive Goods states 220 and 315, Make Payment states 225 and 320, and transitions 230b, 330a, 230d and 330b may be assigned the single line format. The states and transitions having the subset {process model 200} which include Approve Large Purchase state 215 and transitions 230a and 230c may be assigned the broken line format. The states and transitions having the subset of models {process model 300} which include Return Goods to Vendor state 325 and transitions 330d may be assigned the double line format.

At block 120, each state and transition may be combined into one process model and displayed using the assigned format. In some example embodiments, one processing model may be automatically selected by the application as the reference model. In other example embodiments, the user may select the processing model to be used as the reference model. The layout of the reference model may then be used as a starting point for the display of the combined model on a user interface. Thus, in the combined model, the states and transitions of the reference model may be positioned or located in the same positions as they are laid out in the original reference model. Any states and transitions appearing in another model but not in the reference model may be positioned using conventional model layout techniques, as will be described in greater detail below.

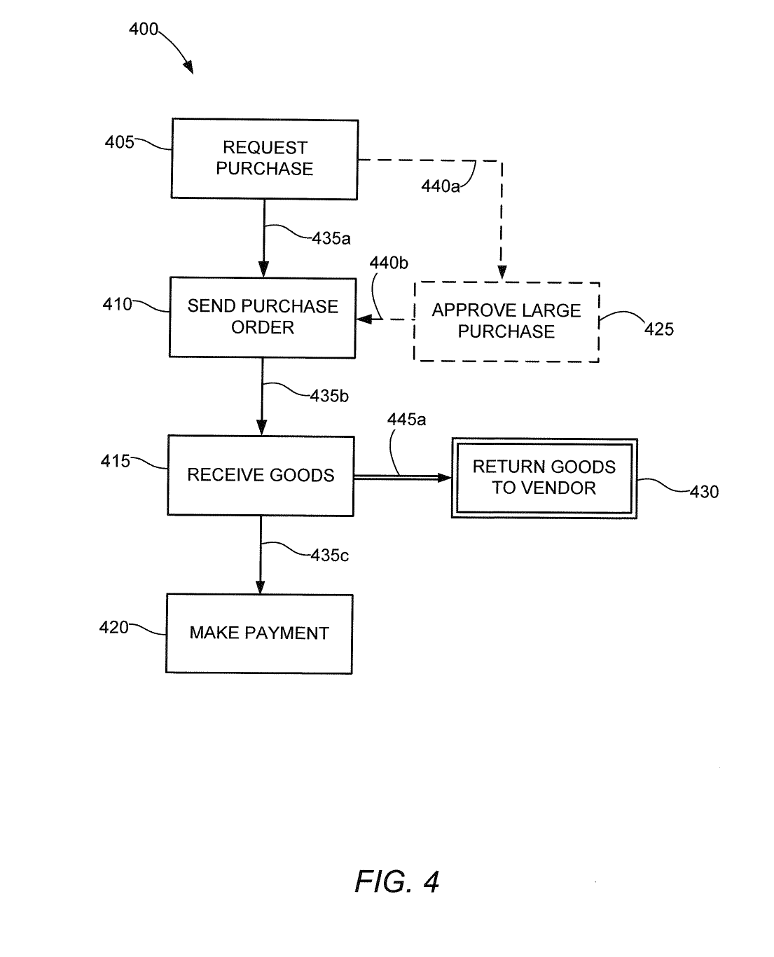

FIG. 4 shows one example combined process model 400 of process models 200 and 300 with process model 200 as the reference model. For illustrative purposes, in combined process model 400, the two process models 200 and 300 are combined in a single model with indicators showing the subsets of each of the state and the transition of both process models 200 and 300. The layout of process model 200, the reference model in this example, may be the foundation for the layout of combined process model 400 with the states and transitions of process model 200 being positioned or located in similar positions on the user interface or display as they are laid out in the original process model 200 of FIG. 2, and the states and transitions occurring in process model 300 but not in reference process model 200 being positioned using various model layout techniques. States and transitions occurring in both process models 200 and 300 are indicated by a single line; states and transitions occurring only in process model 200 are indicated by a broken line; and states and transitions occurring only in process model 300 are indicated by a double line.

For example, Request Purchase state 205 and 305 are determined to occur in both process models 200 and 300 and therefore, have a subset of {process model 200, process model 300}, with an assigned format of a single line. In combined process model 400, Request Purchase state 205 and 305 are represented as Request Purchase state 405 formatted with single line. Other states and transitions that occur in both process models 200 and 300 are indicated with the single line format and include: Send Purchase Order state 410, corresponding to Send Purchase Order states 210 and 310; Receive Goods state 415, corresponding to Receive Goods states 220 and 315; Make Payment state 420, corresponding to Make Payment states 225 and 320; and transitions 435a, 435b and 435c, corresponding to transitions 230b, 330a; 230d and 330b; and 230e and 330c, respectively.

In combined process model 400, states and transitions which occur only in process model 200, the reference model, are indicated by a broken line format. These states and transitions include: Approve Large Purchase state 425, corresponding to Approve Large Purchase state 215, and transitions 440a and 440b, corresponding to transitions 230a and 230c, respectively.

In combined process model 400, states and transitions which occur only in process model 300 and therefore having the subset {process model 300} are indicated by a double line format. These states and transitions include: Return Goods to Vendor state 430, which corresponds to Return Goods to Vendor state 325; and transition 445a, which corresponds to transition 330d.

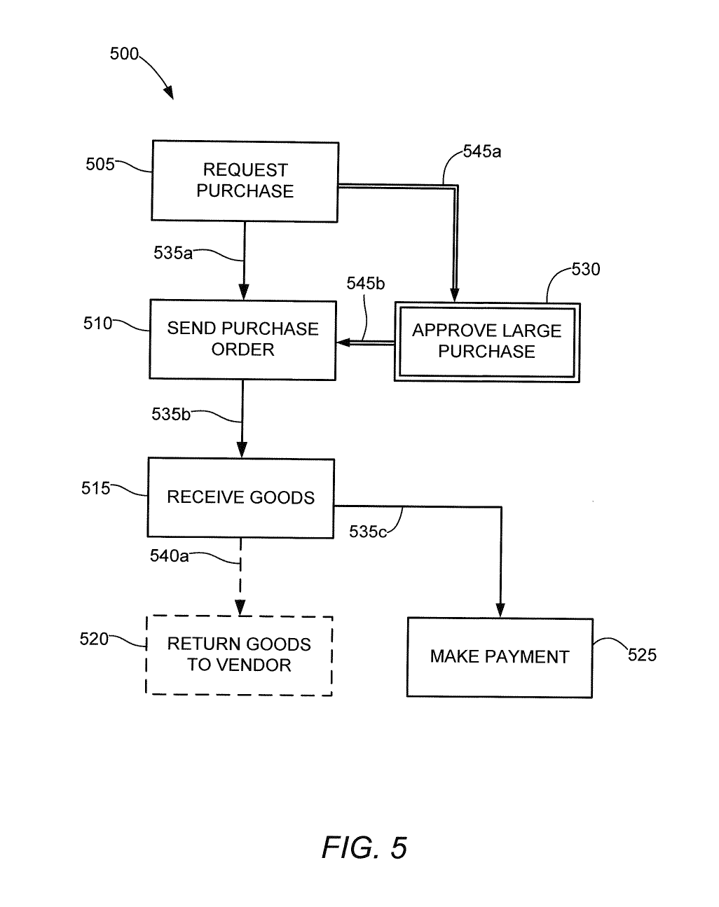

FIG. 5 shows a second example combined process model 500 of process models 200 and 300 with process model 300 as the reference model. In combined process model 500, the two process models 200 and 300 may be combined in a single model with indicators showing the subsets of each of the state and the transition of both process models 200 and 300. The layout of process model 300 may be the foundation for the layout of combined process model 500, with the states and transitions of process model 300, the reference model in this example, being positioned or located in similar positions on the user interface as they are laid out in the original process model 300 of FIG. 3, and the states and transitions occurring in process model 200 but not in the reference process model 300 being positioned using various model layout techniques. States and transitions occurring in both process models 200 and 300 are indicated by a single line; states and transitions occurring only in process model 200 are indicated by a double line; and states and transitions occurring only in process model 300 are indicated by a dotted line.

For example, the states and transitions having the subset {process model 200, process model 300} may be assigned the single line format to indicate that the states and transitions have the same subsets and/or that they occur in both process models 200 and 300. The matching or common states and transitions of process models 200 and 300 are illustrated with a single line format in FIG. 5 and include: Request Purchase state 505, corresponding to Request Purchase states 205 and 305; Send Purchase Order state 510, corresponding to Send Purchase Order states 210 and 310; Receive Goods state 515, corresponding to Receive Goods states 220 and 315; Make Payment state 525, corresponding to Make Payment states 225 and 320; and transitions 535a, 535b, 535c, corresponding to transitions 230b, 330a; 230d and 330b; and 230e and 330c, respectively.

In combined process model 500, states and transitions which occur only in process model 200 and therefore having the subset {process model 200} are indicated by a double line format. These states and transitions include: Approve Large Purchase state 530, corresponding to Approve Large Purchase state 215, and transitions 545a and 545b, corresponding to transitions 230a and 230c, respectively.

In combined process model 500, states and transitions which occur only in process model 300, the reference model, are indicated by a broken line format. The state and transition include: Return Goods to Vendor state 520, which corresponds to Return Goods to Vendor state 325, and transition 540a which corresponds to transition 330d.

In some alternative example embodiments, states and transitions appearing in one model but not in the reference model may be place in a default location in the user interface or display, such as in one of the corners. In one aspect of this example embodiment, states and transitions occurring in one model but not in the reference model may be positioned to the side of the reference model structure.

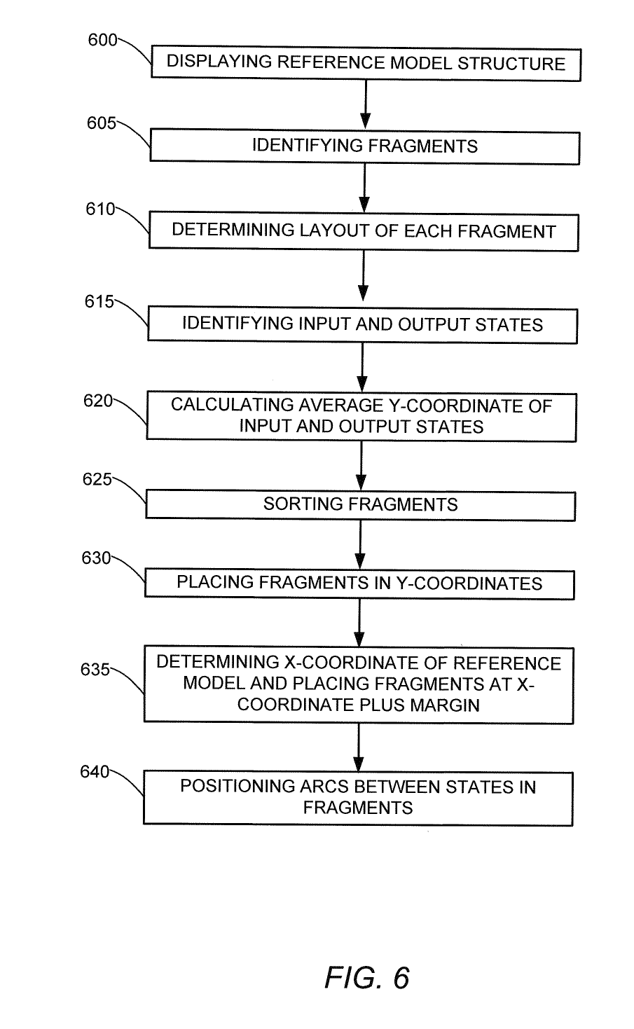

FIG. 6 shows one example embodiment of a method of positioning on a user interface or display states and transitions that occur in one process model but not in a reference model when comparing two or more process models.

At block 600, the reference model structure, or the states and transitions that appear in the reference model, may be displayed on the user interface or display in a layout that is substantially similar to the layout used to display the reference model.

At block 605, fragments may be identified. Fragments may be groups of one or more states that may have transitions between such states. In one alternative example embodiment, fragments may be groups of one or more states that are not found in the reference model. For example, in FIG. 4 which uses process model 200 as the reference model, an identified fragment may include Return Goods to Vendor state 430, indicated with a double-line format because such state does not occurring in process model 200. In another example, in FIG. 5 which uses process model 300 as the reference model, an identified fragment may include Approve Large Purchase state 530, indicated with a broken line format because such state does not occur in reference process model 300.

At block 610, each fragment's states and transitions may be positioned in an isolated layout using conventional layout algorithms. Conventional layout algorithms that may be utilized may include, but are not limited to, hierarchical layout, force directed layout, and organic layout.

At block 615, inputs to and outputs from each fragment to the reference model structure may be identified. The inputs and outputs are states in the original reference model structure, which have transitions to or from states in a given fragment. For example, Return Goods to Vendor state 430 in FIG. 4 is a state that does not occur in the reference model, process model 200, but is connected to the Receive Goods state 415 of the reference model. Thus, Receive Goods state 415 in the reference model may be identified as an input of the fragment that contains Return Goods to Vendor state 430.

In another example, Approve Large Purchase state 530 in FIG. 5 is a state that does not occur in the reference model, process model 300, but is connected to Request Purchase state 505 and Send Purchase Order 510, which do not occur in the reference model. Thus, Request Purchase state 505 may be identified as an input and Send Purchase Order state 510 may be identified as an output for the fragment that contains Approve Large Purchase state 530.

At block 620, the average y-coordinate of all input and output states identified at block 615 may be calculated. The average y-coordinate of all input and output states identified corresponds to the vertical position of the fragment relative to the reference model structure.

At block 625, the fragments identified may be sorted based on the calculated average y-coordinate. Sorting the fragments may include identifying which of the fragments are to be displayed from top to bottom relative to the calculated average y-coordinate and to the reference model structure.

At block 630, each fragment may be placed on the calculated y-coordinate provided the fragments do not have an overlap in layout. If an overlaps occurs, the overlapping fragments may be moved or shifted horizontally until each of the overlapping fragments are sufficiently apart from each other so as to not overlap.

At block 635, a right-most x-coordinate position of the reference model structure may be determined and all fragments may be placed at the calculated x-coordinate plus margin. In one alternative example embodiment, the x-coordinate may be from the left-most coordinate position of the reference model structure, thus placing all the identified fragments to the left of the reference model structure. In one aspect, the margin may be automatically calculated. In another aspect, the margin may be specified by a user.

At block 640, conventional layout algorithms may be used to place arcs that represent the transitions between the states in the reference model structure. Conventional layout algorithms may also be used to place transitions between states in the reference model and fragments as well as transitions not existing in the reference model. Conventional layout algorithms may be edge-routing algorithms such as, for example, organic edge routing and orthogonal edge routing.

In one example embodiment, additional information regarding the process models and the data set with which they represent may be added. Such additional information may include, but is not limited to, performance information such as, for example, process times, waiting times, number of times a particular state is used, accessed or implemented.

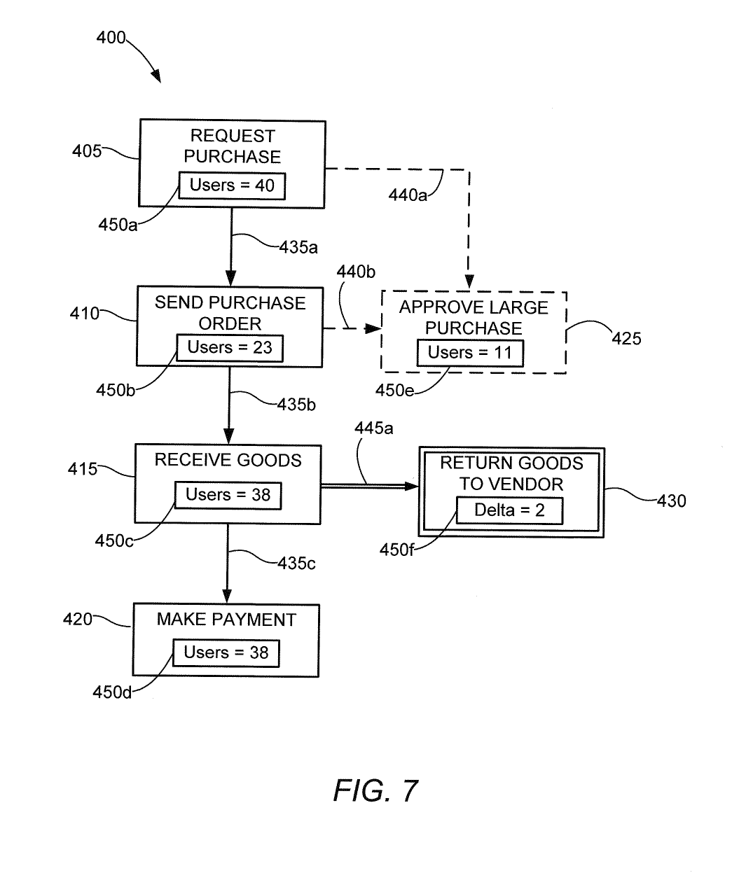

FIG. 7 is a second example combined process model 400 of process models 200 and 300, with process model 200 as the reference process model, in accordance with another aspect of the present disclosure.

In one aspect of this example embodiment, combined process model 400 may display indicators that represent one or more information about a state or a transition. For example, the displayed indicators may represent the number of cases reaching a given state or the number of cases that transition from one state to another. In some example embodiments, the displayed indicators may also represent performance metrics, such as processing times for cases or waiting times for states. It will be apparent by one of ordinary skill in the art that other information may be represented the indicators, that more than one type indicator may be displayed for a given state or transition, and that not all states or transitions may include an indicator. In one example embodiment, individual process models that are not compared or combined may also include indicators.

For example, indicator 450a may display the number of users that invoke Request Purchase state 405; indicator 450b may display the number of users that invoke Send Purchase Order state 450b; indicator 450c may display the number of users that invoke Receive Goods state 450c; indicator 450d may display the number of users that invoke Make Payment state 450d; and indicator 450e may display the number of users that invoke Approve Large Purchase state 450e.

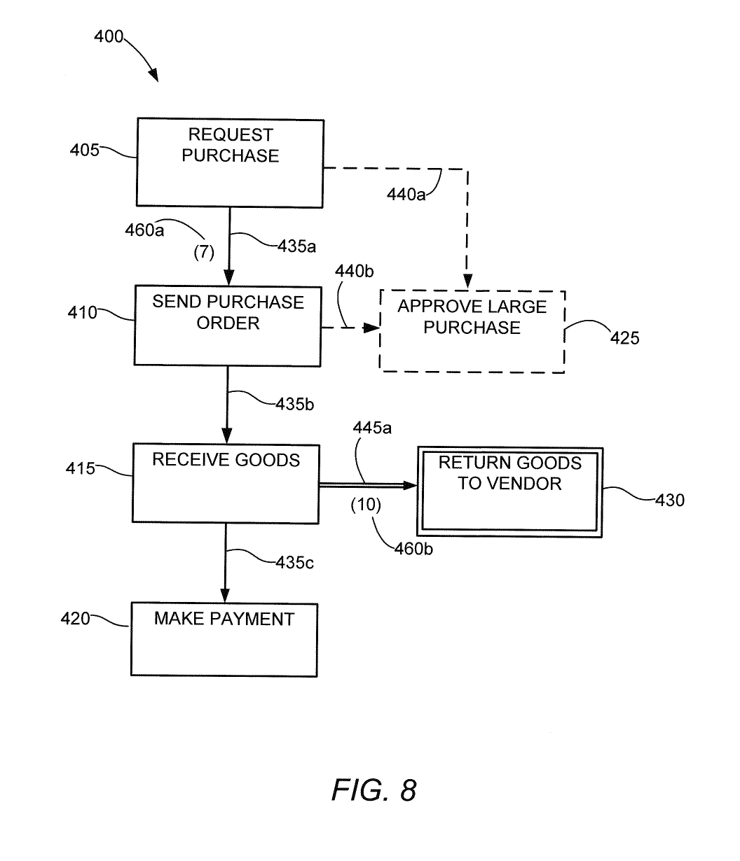

FIG. 8 is third example combined process model 400 of process models 200 and 300, with process model 200 as the reference process model, in accordance with yet another aspect of the present disclosure. Combined process model 400 may display transition indicators that represent one or more information about a transition, such as the number of cases or process instances in transition from one state to another during a given time period or other performance metrics. For example, displayed indicator 460a having a value of 7 may represent the number of days that it takes a purchase order request at Request Purchase State 405 to be sent to the supplier or reach Send Purchase Order state 410. In another example, displayed indicator 460b having a value of 10 may represent the number of goods received at Receive Goods state 415 that are being returned or transitioned to the vendor at Return Goods to Vendor state 430.

In another aspect of this example embodiment, combined process model 400 may display indicators referring to the calculated delta between performance measures of the reference model and other process model(s) being compared to the reference model. For example, the performance measures may refer to one or more measurements that denote how well a process is performed, such as the amount of time a state of a particular process model is accessed or the amount of time it takes for a user to transition from one state to another. Other data, such as the number of users that access a given state for a particular process model, may also be used as a performance measure. It will be apparent to one of ordinary skill in the art that other performance measures may be used in lieu of or in conjunction with performance measures enumerated in this example embodiment.

As shown in FIG. 7, a calculated delta 450f may be displayed in state 430 of combined process model 400. For illustrative purposes, the performance measure of the reference model for combined process model 400 may have a value of 4, while the performance measure of the process model being compared to the reference model in combined process model 400 may have a value of 2. Thus, a calculated delta 450e in FIG. 7 may be displayed as having a value of 2 which indicates that the difference between the performance measures between the reference model and another process model is 2.

In yet other alternative example embodiments, states that do not occur in the reference model but occur in another process model may be displayed as separate process models with indicators showing the differences. In one aspect, such display of separate models may occur on the same screen. In another aspect, such display of separate models may occur in different screens. In still other alternative example embodiments, the indicators may be displayed on the separate input process models. Such indicators may include formatting such as color, line type, patterns, and many others as will be known by one of ordinary skill in the art.

It will be appreciated that the actions described and shown in the example flowcharts may be carried out or performed in any suitable order. It will also be appreciated that not all of the actions described in FIG. 1 or 6 need to be performed in accordance with the example embodiments of the disclosure and/or additional actions may be performed in accordance with other example embodiments of the disclosure.

While the example embodiments are illustrated using two process models, it will be appreciated by those of ordinary skill in the art that more than two process models may be compared or that one process model over different time periods may be compared.

Many modifications and other embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A method of comparing process models, comprising:
identifying similarities and differences in states and transitions of at least two process models; and
visually representing the at least two process models in a user interface,
wherein the differences in the states and the transitions of the at least two process models are indicated in a format different from a format that indicates the similarities in the transitions and the states of the at least two process models.

2. The method of claim 1, further comprising mining a data set to generate at least one of the at least two process models.

3. The method of claim 1, wherein the identifying the similarities in the at least two process models includes identifying labels common to the states of the at least two process models.

4. The method of claim 1, wherein the format for indicating the differences is a first color and the format for indicating the similarities is a second color.

5. The method of claim 1, wherein the format for indicating the differences is a first line type and the format for indicating the similarities is a second line type.

6. The method of claim 1, wherein the format for indicating the differences is a first pattern and the format for indicating the similarities is a second pattern.

7. The method of claim 1, wherein the visually representing the at least two process models comprises visually representing the at least two process models as a single process model.

8. The method of claim 7, wherein the single process model shows the differences in a format different from a format that shows the similarities.

9. The method of claim 1, wherein the visually representing the at least two process models includes positioning the states and the transition occurring in a first process model in a layout that preserves a structure of the first process model.

10. The method of claim 1, wherein performance information regarding the at least two process models is displayed.

11. A method of comparing process models, comprising:
comparing states and transition of at least two process models; and
visually representing the process models in a user interface,
wherein the state and the transition of the process models are indicated in a format corresponding to a subset of the process models in which the state and the transition occurs.

12. The method of claim 11, further comprising mining a data set to generate at least one of the process models.

13. The method of claim 11, wherein the identifying if the transition occurs in the at least two process models includes determining if an input state and an output state of the transition occurring in the first process model is similar in the second process model.

14. The method of claim 13, wherein if the input state and the output state is the same for the transitions in the at least two process models, the transition occurs in the at least two process models.

15. The method of claim 11, wherein the identifying the process models in which the states occur includes matching a state label in a first process model in each of the states in the process model that is not the first process model.

16. The method of claim 11, wherein the format corresponding to the subset of the process models in which the state occurs is indicated by a first color.

17. The method of claim 11, wherein the format corresponding to the subset of the process models in which the transition occurs is indicated by a first line type.

18. The method of claim 11, wherein the visually representing the process models includes visually representing a single process model containing one or more formats indicating the subsets of the process models in which the state and the transition occurs.

19. A method of comparing at least two models, comprising:
identifying whether each state and transition of each of the at least two models appears in each of the at least two models; and
visually representing the at least two models in a user interface,
wherein the states and the transitions that appear in each of the at least two models are visually represented in a first format;
wherein the states and the transitions that appear a first of the at least two models but not in a second of the at least two models are visually represented in a second format; and
wherein the states and the transitions that appear in the second of the at least two models but not in the first of the at least two models are visually represented in a third format.

20. A non-transitory computer-readable storage medium containing executable instructions for performing a method, comprising:
receive at least two process models;
compare states and transitions of the at least two process models;
identify differences in the states and the transitions of the at least two process models; and
visually represent the at least two process models in a user interface,
wherein the differences in the states and the transitions of the at least two process models are indicated in a format different from a format that indicates the similarities in the transitions and the states of the at least two process models.
